(19) United States
(12) Patent Application Publication
(10) Pub. No.: US 2014/0214838 A1
(43) Pub. Date: Jul. 31, 2014

(54) METHOD AND SYSTEM FOR PROCESSING LARGE AMOUNTS OF DATA

(71) Applicant: VertaScale, Menlo Park, CA (US)

(72) Inventor: Geoffrey R. HENDREY, San Francisco, CA (US)

(73) Assignee: VertaScale, Menlo Park, CA (US)

(21) Appl. No.: 14/168,945

(22) Filed: Jan. 30, 2014

Related U.S. Application Data
(60) Provisional application No. 61/758,691, filed on Jan. 30, 2013.

(51) Int. Cl. G06F 17/30

(52) U.S. Cl. CPC G06F 17/30622; G06F 17/30598
USPC 707/737

(57) ABSTRACT

A method of processing data by creating an inverted column index is presented. The method entails categorizing words in documents according to data type, generating a posting list for each of the words that are categorized, and organizing the words in an inverted column index format. In an inverted column index, each column represents a data type, and each of the words is encoded in a key and the posting list is encoded in a value associated with the key. In some cases, the words that are categorized may be the most commonly appearing words arranged in the order of frequency of appearance in each column. This indexing method provides an overview of words that are in a large dataset, allowing a user to choose the words that are of interest to him and “drill down” into contents that include that word by way of queries.

### CROSS-REFERENCE TO RELATED APPLICATION

This application claims the benefit of U.S. Provisional Application No. 61/758,691 that was filed on Jan. 30, 2013, the content of which is incorporated by reference herein.

### FIELD OF INVENTION

This disclosure relates generally to data processing, and in particular to simplifying large-scale data processing.

### BACKGROUND

Large-scale data processing involves extracting data of interest from raw data in one or more data sets and processing it into a useful product. Data sets can get large, frequently gigabytes to terabytes in size, and may be stored on hundreds or thousands of server machines. While there have been developments in distributed file systems that are capable of supporting large data sets (such as Hadoop Distributed File Systems and S3), there is still no efficient and reliable way to index and process the gigabytes and terabytes of data for ad-hoc querying and turn them into a useful product or extract valuable information from them. An efficient way of indexing and processing large-scale data is desired.

### SUMMARY

In one aspect, the inventive concept pertains to a computer-implemented method of processing data by creating an inverted column index is presented. The method entails categorizing words in a collection of source files according to data type, generating a posting list for each of the words that are categorized, and organizing the words in an inverted column index format. In an inverted column index, each column represents a data type, and each of the words is encoded in a key and the posting list is encoded in a value associated with the key. In some cases, the words that are categorized may be the most commonly appearing words arranged in the order of frequency of appearance in each column. This indexing method provides an overview of words that are in a large dataset, allowing a user to choose the words that are of interest to him and “drill down” into contents that include that word by way of queries.

In another aspect, the inventive concept pertains to a non-transitory computer-readable medium storing instructions that, when executed, cause a computer to perform a method for processing data using an inverted column index. The method entails accessing source files from a database and creating the inverted column index with words that appear in the source files. The inverted column index is prepared by categorizing words according to data type, associating a posting list for each of the words that are categorized, and organizing the words in an inverted column index format, with each column representing a data type, wherein each of the words is included in a key and the posting list is included in a value associated with the key.

In yet another aspect, the inventive concept pertains to a computer-implemented method of processing data by creating an inverted column index. The method entails categorizing words in a collection of source files according to data type, generating a posting list for each of the words that are categorized, encoding a key with a word of the categorized words, its data type, its column ordinal, an identifier for the source file from which the word came, the word's row position in the source file document, and a facet status to create the inverted column index, and encoding a value with the key by which the value is indexed and the posting list that is associated with the key. The method further entails selecting rows of the source files and faceting the selected rows by storing the selected rows in a facet list, indicating, by using the facet status of a key, whether the row in the key is faceted, in response to a query including a word and a column ordinal, using the keys in the inverted column index to identify source files that contain the word and the column of the query that are faceted, and accessing the facet list to parse the faceted rows in an inverted column index format to allow preparation of a summary distribution or a summary analysis that shows most frequently appearing words in the source files that match the query.

### BRIEF DESCRIPTION OF THE DRAWINGS

FIG. 1 depicts a general system layout for a large-scale data processing.

FIG. 2 depicts a source file definition process that may be useful for defining columns from a source data file.

FIG. 3 depicts an example of a columnar structure source data file.

FIG. 4 depicts an indexing process.

FIG. 5 depicts an example of a summary distribution that may be generated by using the indexing process of FIG. 4.

FIG. 6 depicts a summary distribution generation process.

FIG. 7 depicts an example of a summary analysis of data that is performed using the summary distribution in response to user request.

### DETAILED DESCRIPTION

In one aspect, the inventive concept includes presenting a summary distribution of content in a large data storage to a user upon the user's first accessing the data storage, before any query is entered. The summary distribution would show the frequency of appearance of the words in the stored files, providing a general statistical distribution of the type of information that is stored.

In another aspect, the inventive concept includes organizing data in a file into rows and columns and faceting the rows at a predefined sampling rate to generate the summary distribution.

In yet another aspect, the inventive concept includes presenting the data in the storage as a plurality of columns, wherein each of the columns represents a key or a type of data and the data cells are populated with terms, for example in order of frequency of appearance. Posting lists are associated with each term to indicate the specific places in the storage where the term appears, for example by document identifier, row, and column ordinal.

In yet another aspect, the inventive concept includes executing a query by identifying a term for a specified ColumnKey. Boolean queries may be executed by identifying respective terms for a plurality of ColumnKeys and specifying an operation, such as an intersection or a union.

In yet another aspect, the inventive concept includes caching results of some operations at client computer and reusing the cached results to perform additional operations.

The disclosure pertains to a method and system for building a search index. A known data processing technique, such as MapReduce, may be used to implement the method and system. MapReduce typically involves restricted sets of application-independent operators, such as a Map operator and a Reduce operator. Generally, the Map operator specifies how input data is to be processed to produce intermediate data, and the Reduce operator specifies how the intermediate data values are to be merged or combined.

The disclosed embodiments entail building an index having a columnar inverted indexing structure that includes posting lists arranged in columns. The inverted indexing structure allows posting lists to be efficiently retrieved and transferred to local disk storage on a client computer on demand and as needed, by a runtime execution engine. Query operations such as intersections and unions can then be efficiently performed using relatively high performance reads from the local disk. The indexing structure disclosed herein is scalable to billions of rows.

The columnar inverted index structure disclosed herein strives to balance performance/scalability with simplicity. One of the contributors to the complexity of search toolkits (e.g., Lucene/Solr) is their emphasis on returning query results with subsecond latency. The columnar inverted indexing method described herein allows the latency constraint to be relaxed to provide search times on the order of a few seconds, and to make it as operationally simple as possible to build, maintain, and use with very large search indexes (Big Data).

The columnar inverted index also provides more than simple “pointers” to results. For example, the columnar inverted index can produce summary distributions over large result sets, thereby characterizing the “haystack in the haystack” in response to user request in real time and in different formats. The columnar inverted index represents a departure from a traditional approach to search and is a new approach aimed at meeting the needs of engineers, scientists, researchers, and analysts.

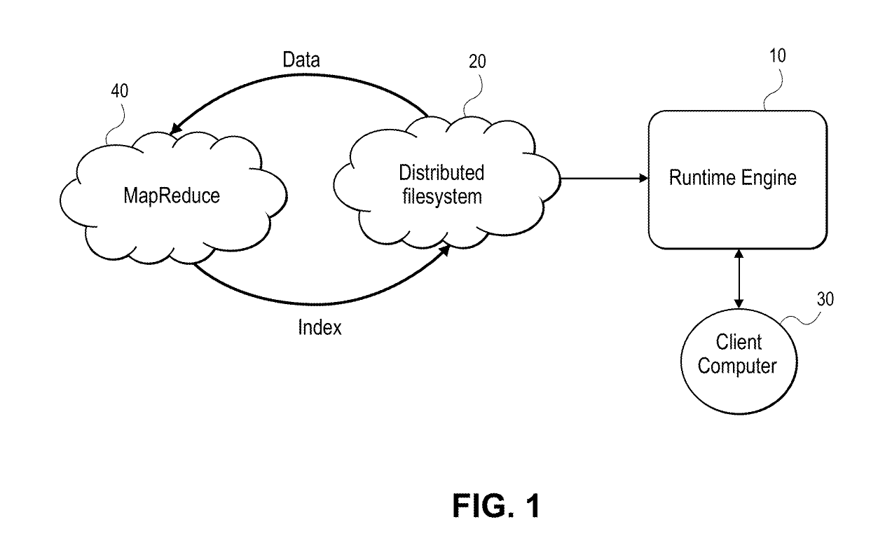

FIG. 1 depicts a general system layout and illustrates how a runtime indexing engine 10 resides between a distributed file system 20 and a client computer 30. Gigabytes and terabytes of data are stored in the distributed file system 20 and preliminarily indexed by a MapReduce engine 40. In one embodiment, the MapReduce engine 40 pulls data from the distributed file system 20 and creates an inverted columnar index with posting lists arranged in columns. The runtime indexing engine 10 performs operations using the inverted columnar index and allows posting lists to be efficiently retrieved and transferred to local disk storage on a client computer 30 on demand.

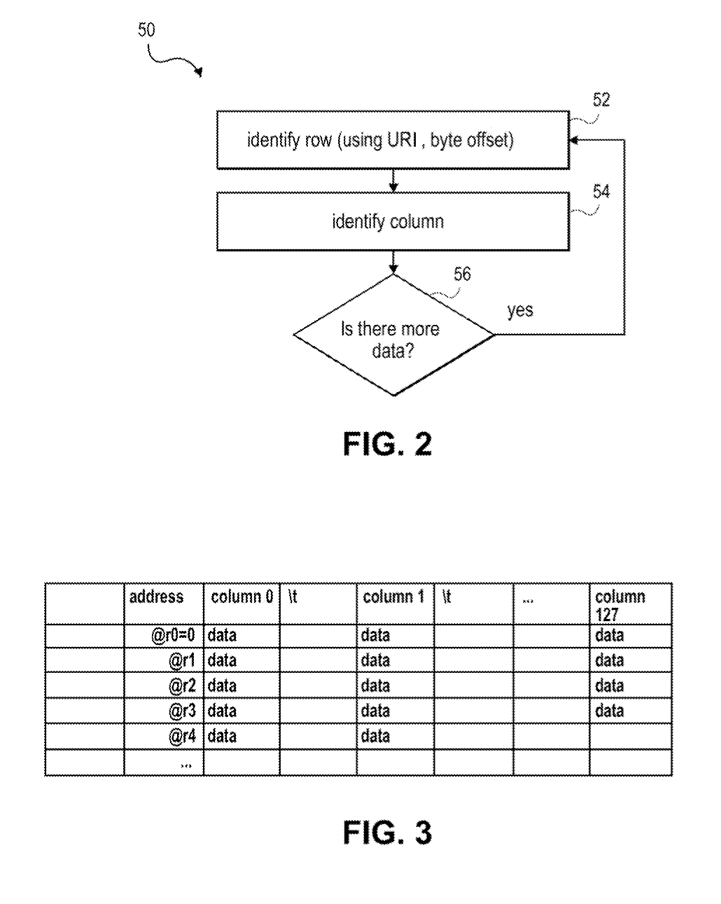

FIG. 2 depicts a source file definition process 50 whereby a columnar data structure is defined in source data files, in accordance with one embodiment of the inventive concept. The source data definition process 50, which generates intermediate data, may be performed by the mapper in MapReduce 40. During the source data definition process 50, a source file is organized into rows and columns in preparation for the indexing. In step 52, a “row” is identified by a file's uniform resource identifier (URI) and a byte offset into the file. The start of a new row is marked by a delimiter, such as “\n,” and different rows may have different numbers of bytes (lengths). In step 54, a “column” is identified by a zero-based ordinal falling between the start of adjacent rows. Columns are separated by delimiter characters, such as a \t (tab), a comma, or other delimiter defined by a descriptor file called parse.json. After identifying the columns in step 54, if there is more data (step 56), the next row is identified (back to step 52) and the process continues in a loop until there is no more data.

FIG. 3 depicts an example of a columnar structure source data file that is defined in the manner depicted in the flowchart of FIG. 2. In the example that is depicted, a file identified by a URI is organized into rows and columns, the rows being @r0, @r1, @r2, etc. and columns being separated by a delimiter \t. In the example of FIG. 3, the @ sign used for the rows denotes physical file addresses. For example, “@r3” is the physical byte offset of the fourth row. The address of the first row is zero, such that @r0=0. With the columnar data model of FIG. 3, every data cell is identified by a tuple (URI, row address, column number). Given this tuple, HDFS or other file system APIs supporting a seek method can open a file at the specified URI, seek to the given row and column address within the file, and read the data. Column delimiters are counted until the count reaches the desired column address. Thus, a reader can reach any data cell with a seek and a short scan.

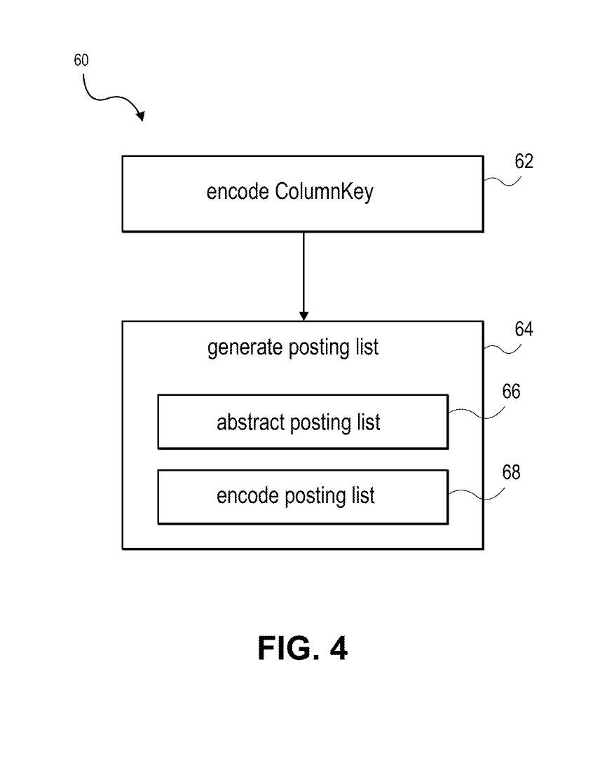

FIG. 4 depicts an indexing process 60 in accordance with one embodiment of the inventive concept. The indexing process 60, which may be executed by the MapReduce engine 40, includes ColumnKey encoding 62 and posting list generation 64. Inverted indexes are created and stored, for example in Sequence Files that have a key and a value for each record. The key encodes information about a term (e.g., “hello”) and other metadata, and the value includes a data array holding an inverted index posting list. A columnar posting list identifies all the places in the distributed file system 20 where a term such as “hello” appears in a given column. The term “hello” may appear in a plurality of columns. A given columnar posting list records the places for a column whose ordinal column number is present in the Posting List's ColumnKey. In the embodiment disclosed, the key is an object called the ColumnKey, and the value is an object called the ColumnFragment. The MapReduce mapper parses source data files and emits ColumnKey objects. Stop words, such as prepositions or articles, may be skipped so that a majority of the ColumnKey objects are meaningful words. The MapReduce reducer collects ColumnKeys and builds the ColumnFragment objects, or the posting list.

Unlike a conventional posting list, the posting lists described herein are columnar so that for each extant combination of term and column (e.g., “hello, column 3”), a posting list exists. The columnar posting lists allow Boolean searches to be conducted using columns and not rows, as will be described in more detail below.

Table 1 below shows the information that ColumnKey encodes during Column Key encoding process 62. The information includes type, term, column, URI, position, and Facet status.

TABLE 1
Information encoded in ColumnKey

| Field | | | |
|---|---|---|---|
| name | Type/size | Description | Notes |
| Type | Int/4 bytes | Enumerated: | Every term occurrence will emit an instance of |
| | | [POSTING \|FACET] | ColumnKey with type = POSTING from the Mapper. |
| | | | Occurrences may also generate instances with |
| | | | type = FACET though this happens at a statistically |
| | | | controlled sampling rate. |
| Term | String/variable | The indexed | |
| | | term (e.g., | |
| | | “hello”) | |
| Column | Byte/1 byte | The column | 0-127 (in one embodiment) |
| | | ordinal | |
| URI | String/variable | Source | Example: |
| | | document URI | s3n://dw.vertascale.com/data/ad/1MRows/2/100kRows.txt |
| Position | Long/8 bytes | Source file row | As described by, for instance @r3 in the source data |
| | | address | model |
| Faceted | Boolean/1 | Is there a | If a term occurrence emits a ColumnKey instance with |
| | byte | corresponding | type = FACET, then its corresponding instance with |
| | | row facet | type = POSTING will have faceted=true |

As mentioned above, MapReduce may be used to build the search index. The ColumnKey object includes a key partitioning function that causes column keys emitted from the mapper to arrive at the same reducer. For the purpose of generating posting lists, the mapper emits a blank value. The ColumnKey key encodes the requisite information. ColumnKeys having the same value for the fields type, term, and column will arrive at the same reducer. The order in which they arrive is controlled by the following ColumnKey Comparator:

```
Public int compareTo (ColumnKey t) {
    if (type != t.type) {
      return type.ordinal( ) > t.type.ordinal( ) ? 1:−1;
    } else if (!term.equals (t.term)) {
      return term.compareTo (t.term);
    } else if (column ! = t.column) {
      return column > t.column ? 1 : −1;
    } else if (!docUri.equals (t.docUri)) {
      return docUri.compareTo (t.docUri);
    } else if (rowPosition ! = t.rowPosition) {
      return rowPosition > t.rowPosition ? 1: −1 ;
    } else {
      return faceted\hat{ }t.faceted? (faceted? 1: −1) : 0; //Boolean
sort (slick, right ..haha. Or just obtuse?)
    }
  }
```

Therefore, the keys are ordered in the following nesting order:

```
Type [POSTING | FACET]
  term
    column ordinal
      document identifier (URI)
        row position
          faceted [true | false]
```

The keys control the sorting of the posting lists. As such, a reducer initializes a new posting list each time it detects a change in either the type, term, or column ordinal fields of keys that it receives. Subsequently, received keys having the same (posting, term, column ordinal) tuple as the presently-initialized posting list may be added directly to the posting list.

A problem in Reducer application code is providing the ability to “rewind” through a reducer's iterator to perform multi-pass processing (Reducer has no such capability in Hadoop). To overcome this problem, the indexing process 60 may emit payload content into a custom rewindable buffer. The buffer implements a two-level buffering strategy, first buffering in memory up to a given size, and then transferring the buffer into an Operating System allocated temporary file when the buffer exceeds a configurable threshold.

The posting list generation process 64 includes a posting list abstraction process 66 and posting list encoding process 68. During the abstraction process 66, posting lists are abstracted as packed binary number lists. The document URI, the row position, and the faceted field are encoded into a single integer with a predetermined number of bits. For example, a single 64-bit integer may break down as follows:

| bits | description |
|---|---|
| 0-39 | row position |
| 40-61 | document identifier |
| 62 | faceted |
| 63 | reserved |

Bits 62 and 63 may be zeroed out with simple bitmask, allowing the process to treat the integer as a 62-bit unsigned number whose value increases monotonically. In this particular embodiment where the lower 40 bits encode the row's physical file address, files up to 2⁴⁰ bytes (1 terabyte) can be indexed. The document identifier (the URI) may be obtained by placing the source file URIs in a lexicographically ordered array and using the array index of a particular document URI as the document identifier. Bits 40-61 (22 bits) encode the document identifier, so up to 2²² or a little more than 4 million documents can be included in a single index. The number of bits used for the row position and the document identifier can be changed as desired, for example so that more documents can be included in a single index at the cost of reducing the maximum indexable length of each document.

During the posting list encoding process 68, successively-packed binary postings are delta-encoded, whereby the deltas are encoded as variable length integers. The following code segment illustrates how the postings may be decoded:

```
Public long nextPosting ( ) throws IOException {
  vInt.readFields (payloadDataInputStream);
  numRead++;
  deltaAccumulator += vInt.get ( ); //add the delta
  return deltaAccumulator & ~FACET_BIT;
  }
```

An object named ColumnFragment encodes posting lists. The encoding is done such that a posting list may be fragmented into separate pieces, each of which could be downloaded by a client in parallel. Table 2 depicts an exemplary format of ColumnFragment, having the following four fields: ColumnKey, sequence number, length, and payload. As shown, the payload is stored as an opaque sequence of packed binary longs, each encoding a posting. As mentioned above, the posting list indicates all the places where the ColumnKey term appears. The posting object does not store each posting as an object or primitive subject to a Hadoop serialization/deserialization event (i.e., “DataInput, DataOutput” read and write methods) as this incurs the overhead of a read or write call for each posting. Packing the postings into a single opaque byte array allows Hadoop serialization of postings to be achieved with a single read or write call to read or write the entire byte array en masse. A Sequence File is output by the Reducer. The SequenceFile's keys are of type ColumnKey, and values are of type ColumnFragment.

TABLE 2
ColumnFragment Format

| Field Name | Type/size | Description |
|---|---|---|
| ColumnKey | ColumnKey/ | A posting list includes the ColumnKey |
| | variable | that it is indexed by. This is convenient and |
| | | made possible by the fact that the length of |
| | | a ColumnKey is small compared to the |
| | | posting list payload |
| Sequence | Int/4 bytes | If fragmenting is used, this is the position of |
| number | | the fragment in the fragmented posting list |
| Length | Long/8 bytes | Size of payload |
| Payload | Byte array/ | Payload consisting of packed binary longs |
| | variable | |

When a particular term-occurrence (posting) is “faceted”, it means the entire row in the source data file in which said posting occurred has been sampled and indexed into the Facet List corresponding to the posting. When a posting list is processed in the indexing process 60, and postings having the faceted bit set in their packed binary representation, the runtime engine 10 is instructed to retrieve said entire row from the Facet List and pass it to the FacetCounter.

A single key in the Sequence File is itself a ColumnKey Object, thus describing a term and column, and the corresponding value in the sequence file is either a posting list or a facet list depending on the type field of the ColumnKey. A sequence file consists of many such key value pairs, in sequence. The Sequence File may be indexed using the Hadoop Map File paradigm. A Map File is an indexed Sequence File (a sequence file with an additional file called the index file). The Map File creates an index entry for each and every posting list. In some cases, the default behavior of a Map File may be set to index one of every 100 entries. In these cases, an index entry would exist for 1 of every 100 ColumnKeys, thereby forcing linear scans from an indexed key to the desired key. On average this would be 50 key-value pairs to be scanned (50 because that would be the average distance between the one of every 100 that is indexed). Therefore, to avoid linear scans, an index entry is generated for each key in the Sequence File. As posting lists can be large binary objects, direct, single seeks are more desirable than a thorough scan through the large posting lists. Therefore, an index entry is generated for each ColumnKey/ColumnFragment pair, and linear scans through vast amounts of data are avoided. The files generated as part of MapReduce reside in a Hadoop compatible file system, such as HDFS and S3.

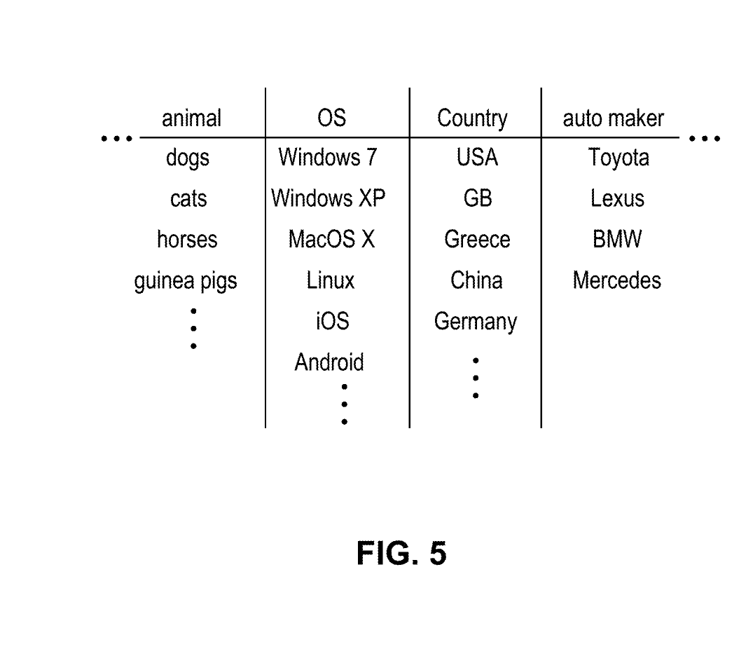

FIG. 5 depicts an example of a summary distribution that results from the above indexing process 60. As shown, a summary distribution includes a plurality of columns, each headed by a ColumnKey. The example that is shown includes “animal,” “operating system,” and “country” as ColumnKeys. The summary distribution presents to a user a big picture of what is most frequently mentioned across all the data. More specifically, the summary distribution shows that out of all the files in the distributed file system, “dogs” are the most common animals, followed by “cats,” “horses,” and “guinea pigs.” As for operating systems, the most commonly mentioned one is “Windows 7,” followed by “Windows XP,” “MacOS X,” “Linux,” “iOS,” and “Android.” As for countries, “USA” appeared most frequently, followed by “Great Britain,” “Greece,” “China,” and “Germany.” As files are added, deleted, and modified in the distributed file system, the summary distribution changes as well to reflect the modification. The indexing process 60 is run each time a new summary distribution is to be generated.

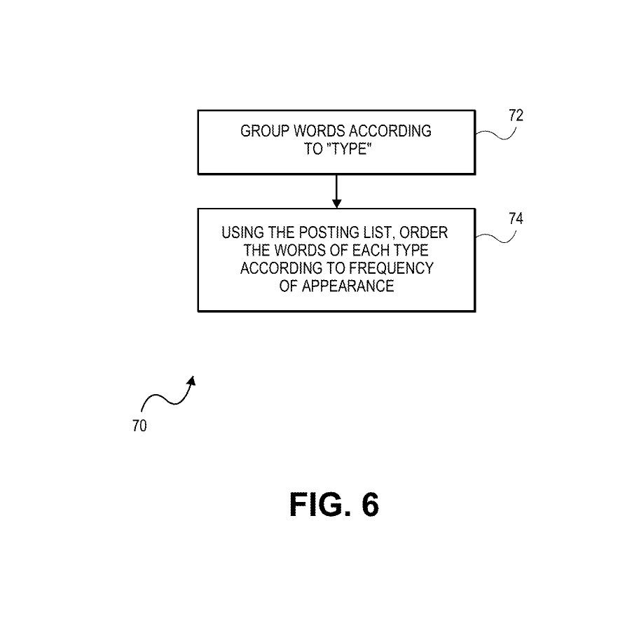

FIG. 6 depicts a flowchart that illustrates summary distribution generation process 70. Words are grouped according to their “type” (such as animals, operating systems, countries, etc.) (step 72) and organized into a set of columns (e.g., 55 columns). Based on the ColumnFragments and the posting list, a preset number of most commonly-appearing words are identified (step 74). As shown in FIG. 5, each column represents a “type” of word, and the words may be provided in the order of frequency of appearance. Summaries could also be created on numeric types, in which case information such as mean, median mode, and RMS deviation would be recorded.

The search index and the summary distribution reside in the distributed file system 20. In one embodiment of the inventive concept, the summary distribution is presented to a user when a user first accesses a distributed file system, as a starting point for whatever the user is going to do. The summary distribution provides a statistical overview of the content that is stored in the distributed file system, providing the user some idea of what type of information is in the terabytes of stored data.

Using the summary distribution as a starting point, the user may “drill down” into whichever field that is of interest to him. For example, in the summary distribution of FIG. 5, the user may click on “iOS” to find out more about the statistical content distribution relating to the operating system “iOS.” In response to this request, the search engine 10 identifies all the files in the distributed file system 20 that contain the word iOS by using the posting list, and runs the summary distribution generation process 70 using just those files. While the columns may remain the same between the original summary distribution that shows the statistics across all the files and the revised summary distribution that shows the statistics across only the files that contain the word iOS, the number of rows may change, as the subgroup of files naturally contain less data than the totality of stored files. If desired, the user can again click on one of the data cells in the revised summary distribution chart to further drill down and obtain more information. For example, after seeing that USA is the country that appears most frequently in all the files that contain the word “iOS,” the user may click on “USA” to get a next-level summary distribution on all the files that contain the words “iOS” and the word “USA.”

To support summary analysis on queries, a posting list may have a corresponding Facet List. A “facet,” as used herein, is a counted unique term, such as “USA” as shown in FIG. 5. A Facet List in the internal index data structure is the list of full rows, from which individual facets are computed at runtime, by the process of parsing the full rows into columns, grouping the columns, and counting the contents of each column group, thereby coming up with a ranked (frequency ordered) set of facets. ColumnFacet lists use the same ColumnFragment data structure as Posting Lists, except that the content of the payload field contains a sequence of sampled source data rows. Rows appearing in the Facet List were selected in the mapper by a “yes” or “no” random variable with a user-defined expectation (e.g., 1% sampling rate means one of 100 rows will be represented in the facet index). The correspondence between a given posting and a sampled row is recorded/indicated by the faceted bit (bit 62, as shown above). As postings are sequentially scanned, any posting having the faceted bit set generates a corresponding read of a row from the Facet List. The row is then passed to the Facet Counter logic where it is parsed into columnar form, and each column value is faceted. Further, for a “bag of words” model in which the order of the words does not matter, the column content itself may be parsed before faceting. At each stage of a query, there is a posting list and a Facet List.

The indexing technique disclosed herein maintains a local disk-based BTree for the purpose of resolving the location of columnar posting list in the distributed file system, or in local disk cache. The runtime engine 10, as part of its initialization process, reads the Map File's Index file out of the distributed file system and stores it in an on-disk BTree implementing the Java NavigableSet<ColumnKey> interface. The ColumnKey object includes the following fields, which are generally not used during MapReduce, but which are populated and used by the runtime engine 10:

| Field Name | Type/size | Description | Notes |
|---|---|---|---|
| indexFileURI | String/ | URI of sequence file | Example: s3n?//myindex/POSTING_r-0003 |
| | variable | containing the posting list | |
| | | for this ColumnKey | |
| indexFilePosition | Long/8 bytes | The position into the | This value comes directly from |
| | | sequence file containing the | the value of the key/value pair |
| | | posting list for this | loaded from the Map File INDEX |
| | | ColumnKey | file. With the combination of |
| | | | indexFileURI and |
| | | | indexFilePosition, the runtime |
| | | | can seek directly to a posting |
| | | | list |
| localFilePath | String/ | Path to a local copy of the | The runtime copies posting lists |
| | variable | posting list (if any exists) | from distributed storage to local |
| | | | storage. Although a |
| | | | “streaming” mode is possible, it |
| | | | is also possible to copy the |
| | | | posting list into cache (i.e., the |
| | | | localFilePath) before |
| | | | performing any operations such |
| | | | as intersection or union |

The ColumnKey objects are stored in a local-disk based BTree, making prefix scanning practical and as simple as using the NavigableSet's headset and tailSet methods to obtain an iterator that scans either forward or backward in the natural ordering, beginning with a given key. For example, to find all index terms beginning with “a,” the tailSet for a ColumnKey with type=POSTING and term=“a” can be iterated over. Notice that not only are all terms that begin with “a” accessible, but all columns in which “a” occurs are accessible and differentiable, due to the fact that the column is one of the fields included in the ColumnKey's Comparator (see above). Term scanning can also be applied to terms that describe a hierarchical structure such as an object “dot” notation, for instance “address.street.name.” Index scanning can be used to find all the fields of the address object, simply by obtaining the tailSet of “address.” For objects contained in particular columns (such as JSON embedded in a column of a CSV file), “dot” notation can be combined with column information, enabling the index to be scanned for a particular object field path and the desired column. Index terms can also be fuzzy matched, for example by storing Hilbert number in the term field of the ColumnKey as described in U.S. patent application Ser. No. 14/030,863.

The drilling down into the summary distribution may be achieved through a Boolean query. For example, instead of clicking on the word “iOS” under the operating system column as described above, a user may type in a Boolean expression such as “column 5=iOS.” The runtime engine 10 parses queries and builds an Abstract Syntax Tree (AST) representation of the query (validating that the query conforms to a valid expression in the process). The Boolean OR operator (|) is recognized as a union, and the Boolean AND operator (&&) is recognized as an intersection operation. A recursive routing is used to execute and pre-order a traversal of the AST. This is best explained by direct examination of the source subroutine. The parameters are as follows:
1. ASTNode—the current node of the AST
2. metaIndex—the Meta Index
3. fc—the FacetCounter. Over large results sets (i.e., a “haystack within a haystack”), summary information can be aggregated to present a “big picture” of the result set, as opposed to a row-by-row presentation of discrete “hits.” It is the function of the FacetCounter to collect and aggregate information.
4. Force—determines whether or not posting lists are to be downloaded (“forced to be downloaded”) or can use an existing local copy. Force is mainly useful for debugging when it is desired to obliterate the local cache on every query.

The result (return type) of the Boolean query is a File array. Every part of the Syntax tree in a Boolean query is cached separately. Therefore, there is no memory data structure consuming memory, such as List or byte array. Although Files are slower to read and write than in-memory data structures, the use of files has several advantages over memory:
1. Intersection and union operations are limited only by the amount of on-disk space, not memory space. Most laptops today have many hundreds of Gigabytes of disk space, but only a few Gigabytes of RAM. Therefore, intersection and union operations inside the disclosed process are designed to be both possible and efficient on laptop computers used by engineers, data scientists, and business analysts.
2. The format of the returned File array is identical regardless of whether the file stores a leaf structure (e.g., a posting list) or an intermediate union or intersection. The homogeneous treatment of leaf data structures, intermediate results, and the final answer itself leads to multiple opportunities for caching and for sharing of intermediate AST node file arrays between different queries. For instance, a cached file array for field[3]==“usa” && field[1]==“iPhone” would be useful for processing the following queries:
   a. (field[3]==“usa” && field[1]==“iPhone”) && field[27]==“Cadillac”
   b. Field[7]==“true” && (field[3]=“usa” && field[1]==“iPhone”)
   The caching of intersections/unions at the client computer 30 for future reuse enhances the efficiency of the process. If there is an extra limitation in addition to the intersection that is cached, only the intersection of the cached value and the extra limitation needs to be determined to obtain the final result.
3. The get IndexColumnFiles method is responsible for downloading index posting lists and storing them as files in the local disk cache at the client computer 30
4. Each File array has two elements. The first is a posting list file, encoded as described above, and the second is row-samples file (i.e., the FacetList).
   In accordance with the inventive concept, the Boolean query is expressed only in terms of columns/fields.

The AST Navigation may be executed as follows:

```
private static File[ ] execute(ASTNode n, NavigableSet<ColumnKey>
metaIndex,
FacetCounter fc, boolean force, int depth)
  throws IOException {
  log.debug(“execute walking ast: ” + n.getClass( ).getName( ));
  if (depth != 0) {
  fc = null; //facets are only counted at the top level of the tree (i.e.
when depth ==0)
  }
  if (n instanceof And) {
      ASTNode left = ((And) n).getLeft( );
      ASTNode right = ((And) n).getRight( );
      File[ ] leftPartialResult = execute(left, metaIndex, fc, force,
    depth +
1);
      File[ ] rightPartialResult = execute(right, metaIndex, fc, force,
    depth +
1);
      String nodeName = n.getAbsoluteName( );
      return ColumnFragmentPostings.intersect(leftPartialResult,
rightPartialResult, nodeName, fc);
  } else if (n instanceof Or) {
      ASTNode left = ((Or) n).getLeft( );
      ASTNode right = ((Or) n).getRight( );
      File[ ] leftPartialResult = execute(left, metaIndex, fc, force,
    depth +
1);
      File[ ] rightPartialResult = execute(right, metaIndex, fc, force,
    depth +
1);
      String nodeName = n.getAbsoluteName( );
      return ColumnFragmentPostings.union(leftPartialResult,
rightPartialResult, nodeName, fc);
  } else if ((n instanceof BinaryOperation)) {
  ColumnEqualsNode cen = new ColumnEqualsNode(n);
  ColumnKey ck = cen.getColumnKey( );
  //we are all the way down to the leaf of the expression, like
field[0]==“x”
  //which directly describes a set of index column files
  File[ ] columnFiles = IndexFileLoader2.getIndexColumnFiles
(ck, metaIndex, force);//force download
  if (0 == depth && null != columnFiles[ColumnKey.Type.FACET.ordinal
  () ]) {
  FacetDecoder dec = new
FacetDecoder(columnFiles[ColumnKey.Type.FACET.ordinal ( ) ]);
  while (dec.hasNext ( )) {
          fc.addRow(dec.nextRow( ));
        }
  }
  return columnFiles;
  } else if (n instanceof Substatement) {
  Substatement s = (Substatement) n;
  //c.handleSubstatement(s); ...doesn't work!
  ASTNode subNode = new
ExpressionCompiler(s.getAbsoluteName( )).compile( ).getFirstNode( );
  return execute(subNode, metaIndex, fc, force, depth);
  } else {
  throw new RuntimeException(“unsupported syntax: ” +
n.getClass( ).getName( ));
    }
  }
```

A PostingDecoder object decodes the posting lists. Two posting lists may be intersected according to the following logic. Note that it is up to the caller of the nextIntersection method to perform faceting if so desired. The Intersection process is carried out as follows:

```
Public static Boolean nextIntersection (PostingDecoder decl, PostingDecoder
dec2)throws IOException {
    try {
      //since they are equal,or just starting (before first posting),
advance both
      long p1 = dec1.nextPosting(false);
      long p2 = dec2.nextPosting(false);
      //System.out.println(dec1.getPosting( ) + “\t” + dec2.getPosting( ));
      //if not yet equal, advance the smaller posting until they are equal
      while(p1 ! = p2) {
        if (p1 < p2) {
          p1 = dec1.nextPosting(false);
        } else {
          p2 = dec2.nextPosting(false);
        }
      //System.out.println(dec1.getPosting( ) + “\t” + dec2.getPosting( ));
      }
      //System.out.println(dec1.getPosting( ) + “\t” + dec1.getDocId( ) +
“\t” + dec1.getRowPosition( ));
      //the two values actually ought to be exactly equal
      Dec1.getPosting(true); //′true′ means collect the output
      return true;
    } catch (EOFException eofe) { //this happens normally when one list is
exhausted
      return false; //no more intersection possible if one of the lists is
exhausted
    }
  }
```

The next intersection is invoked as follows:

```
while (PostingDecoder.nextIntersection(decoder1, decoder2)) {
  if (log.isDebugEnabled( )) {
        if (decoder1.getPosting( ) <= prev) {//perform monitonicity
check if debug enabled
          throw new RuntimeException(“monotonicity check failed.
current: ” + decoder1.getPosting( ) + “<=” + prev);
        }
    }
    //System.out.println(“row delta:”+(decoder1.getRowPosition( ) −
PostingDecoder.decodeRowPosition(prev)));
    hitCount++;
    //collect facets from either FacetDecoder (since they will both
hold the whole row,
    //it is wrong to use both as it double counts)
  if (decoder1.isFaceted( )) {
        //System.out.println(facetDecoder1.getRow( ));
        facetRow = facetDecoder1.getRow(true);
        if (null != facetCounter) {
          facetCounter.addRow(facetRow);
        }
      } else if (decoder2.isFaceted( )) {
        //System.out.println(facetDecoder2.getRow( ));
        facetRow = facetDecoder2.getRow(true);
        if (null != facetCounter) {
          facetCounter.addRow(facetRow);
        }
      }
  }
```

The Union operation's logic finds all elements of the union, stopping at the first intersection. Consequently, the caller passes in the FacetCounter so that the potentially numerous elements of the union may be faceted without returning to the calling code. The Union process is executed as follows:

```
Public static long collectUnions(PostingDecoder dec1, PostingDecoder dec2,
FacetCounter facetCounter) throws IOException {
  String facetRow = null;
  //if 1 is tapped out, advance 2
  if ((!dec1.hasNext( )) && dec2.hasNext( )) {
      collectNext (dec2, facetCounter);
      return 1;
  }
  //if 2 is tapped out, advance 1
  if (dec1.hasNext( ) && !dec2.hasNext( )) {
      collectNext(dec1, facetCounter);
      return 1;
  }
  if (!dec1.hasNext( ) && !dec2.hasNext( )) {
      return 0; //both exhausted, finished
  }
  //otherwise they are equal, or just starting (before first posting),
advance both without collecting result
  long p1 = dec1.nextPosting(false);
  long p2 = dec2.nextPosting(false);
  //System.out.println(dec1.getPosting( ) + “\t” + dec2.getPosting( ));
  //collect and advance the smaller posting value, until they are equal
  long count = 0;
  while (p1 != p2) {
    if (p1 < p2) {
        count++;//this needs to be done here, cause nextPosting can EOF,
so you can't consolidate this outside the if
        collect(dec1, facetCounter);
        try {
          p1 = dec1.nextPosting(false); //advance the smaller p
        } catch (EOFException e) {
          collect(dec2, facetCounter);//shorter list ran out, must
collect larger value
          return ++count;
        }
      } else {
        count++;
        collect(dec2, facetCounter);
        try {
          p2 = dec2.nextPosting(false); //advance the smaller p
        } catch (EOFException e) {
          collect(dec1, facetCounter); //shorter list ran out, must
collect larger value
          return ++count;
        }
      }
      //System.out.println(dec1.getPosting( ) + “\t” + dec2.getPosting( ));
  }
  //System.out.println(dec1.getPosting( ) + “\t” + dec1.getDocId( ) + “\t” +
dec1.getRowPosition( ));
  //the two values p1, p2, are now equal
  count++;
  collect(dec1, facetCounter);
  //now, we have just collected the posting, and possibly the facet. But
what if dec1 wasn't faceted and dec2 is?
  //then we now have the chance to collect just the facet from dec2.
  if (!dec1.isFaceted( ) && dec2.isFaceted( )) {
    collectFacetOnly(dec2, facetCounter);
    }
    Return count;
  }
```

The CollectUnions process is invoked as follows:

```
while ((unions=PostingDecoder.collectUnions(decoder1, decoder2,
  facetCounter))>0) {
      hitCount += unions;
    }
    if (null !+ facetCounter) {
    facetCounter.setHitCount(hitCount);
    }
```

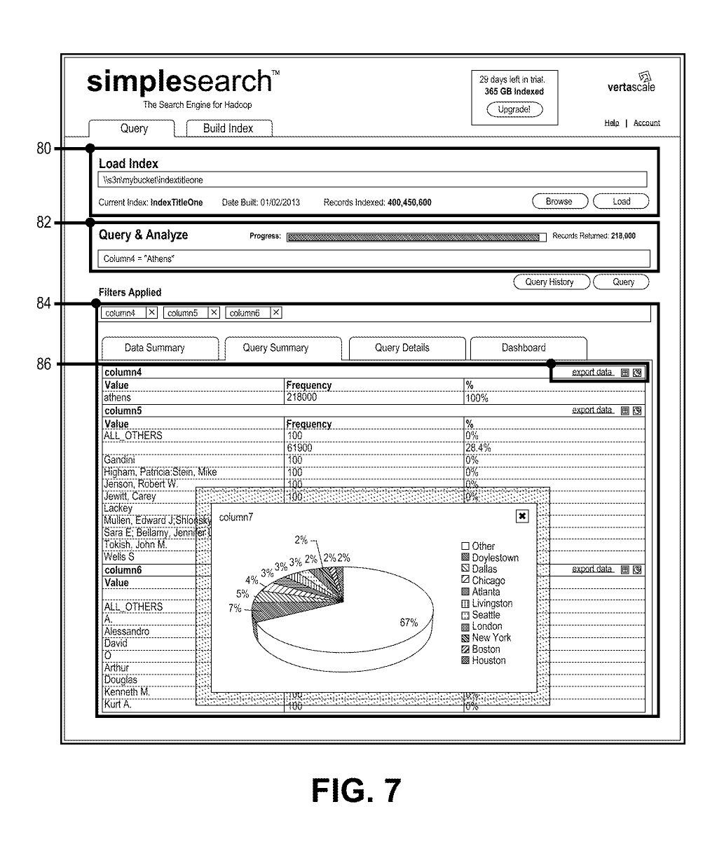

FIG. 7 depicts an example of a summary analysis of data that is performed using the above-mentioned summary distribution and presented to a user (e.g., in response to a query). As shown, an index 80 and a query 82 are requested and received from a user, who is at the client computer 30. In the particular example, the query is entered as “Column 4=‘Athens’.” A Summary Analysis 84 provides summaries of large datasets, in this case as columns and graphs. The query summary 86 shows that the term “Athens” appears 218,000 times in column 4. Where other filters are applied, query results showing those filters may also be shown (here, Columns 5 and 6 are shown as examples). Had the user been using a typical SQL query, he would have received, in response to his query, 218,000 rows of data containing “Athens” in column 4. With the Summary Analysis feature, however, the user can quickly see the distribution of all the other columns—for example that Column 4=city, column 22=Gender, and column 23=Income level. This summary analysis would immediately reveal to the user the gender breakdown and income breakdown for everyone in “Athens,” saving the user a number of additional steps that he would typically have to be executed separately using SQL.

Various embodiments of the present invention may be implemented in or involve one or more computer systems. The computer system is not intended to suggest any limitation as to scope of use or functionality of described embodiments. The computer system includes at least one processing unit and memory. The processing unit executes computer-executable instructions and may be a real or a virtual processor. The computer system may include a multi-processing system which includes multiple processing units for executing computer-executable instructions to increase processing power. The memory may be volatile memory (e.g., registers, cache, random access memory (RAM)), non-volatile memory (e.g., read only memory (ROM), electrically erasable programmable read only memory (EEPROM), flash memory, etc.), or combination thereof. In an embodiment of the present invention, the memory may store software for implementing various embodiments of the present invention.

Further, the computer system may include components such as storage, one or more input computing devices, one or more output computing devices, and one or more communication connections. The storage may be removable or non-removable, and includes magnetic disks, magnetic tapes or cassettes, compact disc-read only memories (CD-ROMs), compact disc rewritables (CD-RWs), digital video discs (DVDs), or any other medium which may be used to store information and which may be accessed within the computer system. In various embodiments of the present invention, the storage may store instructions for the software implementing various embodiments of the present invention. The input computing device(s) may be a touch input computing device such as a keyboard, mouse, pen, trackball, touch screen, or game controller, a voice input computing device, a scanning computing device, a digital camera, or another computing device that provides input to the computer system. The output computing device(s) may be a display, printer, speaker, or another computing device that provides output from the computer system. The communication connection(s) enable communication over a communication medium to another computer system. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media includes wired or wireless techniques implemented with an electrical, optical, RF, infrared, acoustic, or other carrier. In addition, an interconnection mechanism such as a bus, controller, or network may interconnect the various components of the computer system. In various embodiments of the present invention, operating system software may provide an operating environment for software's executing in the computer system, and may coordinate activities of the components of the computer system.

Various embodiments of the present invention may be described in the general context of computer-readable media. Computer-readable media are any available media that may be accessed within a computer system. By way of example, and not limitation, within the computer system, computer-readable media include memory, storage, communication media, and combinations thereof.

Having described and illustrated the principles of the invention with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

While the exemplary embodiments of the present invention are described and illustrated herein, it will be appreciated that they are merely illustrative.

What is claimed is:

1. A computer-implemented method of processing data by creating an inverted column index, comprising:
categorizing words in a collection of source files according to data type;
generating a posting list for each of the words that are categorized; and
organizing the words in an inverted column index format, with each column representing a data type, wherein each of the words is encoded in a key and the posting list is encoded in a value associated with the key.

2. The method of claim 1, wherein the words that are categorized are most commonly appearing words in the collection of source files excluding stop words.

3. The method of claim 1 further comprising listing words in a column in the order of their frequency of appearance in the source files.

4. The method of claim 1 further comprising storing the posting list on a remote computer, and accessing the posting list from the remote computer for processing.

5. The method of claim 1, further comprising:
organizing data in the source files into rows and columns;
selecting a subset of rows for faceting, wherein faceting comprises sampling of an entire row in the source files; and
storing the faceted rows in a facet list.

6. The method of claim 5 further comprising encoding the following information into the key for each of the words:
data type of the word;
the word;
a column ordinal;
a source file document identifier;
a source file row address identifying the row that contains the word; and
a facet status indicating whether a row is selected for faceting.

7. The method of claim 6 further comprising representing posting lists as binary number lists by encoding a single binary number with a document identifier, a row position, and the facet status.

8. The method of claim 1 further comprising encoding the value with the following information:
a key under which the value is indexed;
a payload of posting lists, wherein each posting list is represented with a packed binary long; and
an indicator of size of the payload.

9. The method of claim 9, wherein the value is further encoded with a sequence number indicating how pieces of a fragmented posting list can be combined.

10. The method of claim 6 further comprising:
receiving a user request including a query word and a query column;
using the key to identify faceted rows that contain the query word in the query column; and
processing the identified faceted rows such that a response to the user request includes at least one of a summary distribution and an analysis computed using the identified facet rows.

11. The method of claim 10 wherein the user request includes an intersection or union operation, further comprising caching every syntax of the query separately.

12. The method of claim 1 further comprising:
receiving a user request including a query word and a query column;
using the query word and query column to identify a posting list; and
using the posting list to identify source documents; and
processing rows from the source documents such that a response to the user request includes at least one of a summary distribution and an analysis computed over the rows from the source documents.

13. The method of claim 12 further comprising selecting a subset of rows for the processing, and processing only the subset of rows from the source document.

14. A non-transitory computer-readable medium storing instructions that, when executed, cause a computer to perform a method for processing data using an inverted column index, the method comprising:
accessing source files from a database;
creating the inverted column index with words that appear in the source files by:
categorizing words according to data type;
associating a posting list for each of the words that are categorized; and
organizing the words in an inverted column index format, with each column representing a data type, wherein each of the words is included in a key and the posting list is included in a value associated with the key.

15. The non-transitory computer-readable medium of claim 14, wherein the method further comprises:
storing the posting list on a remote computer; and
accessing the posting list from the remote computer for processing.

16. The non-transitory computer-readable medium of claim 14, wherein organizing the words in inverted column index format comprises:
organizing data in the source files into rows and columns;
selecting a subset of rows to be faceted, wherein faceting comprises sampling of an entire row in the source files; and
storing the faceted rows in a facet list.

17. The non-transitory computer-readable medium of claim 16, wherein the method further comprises encoding the following information into the key for each of the words:
data type of the word;
the word;
a column ordinal;
a source document identifier;
a source file row address identifying the row that contains the word; and
a facet status indicating whether the row is selected for faceting.

18. The non-transitory computer-readable medium of claim 16, wherein the method further comprises representing posting lists as binary number lists by encoding a single binary number with a document identifier, a row position, and the facet status.

19. The non-transitory computer-readable medium of claim 16, wherein the method further comprises encoding the following information into a value for each of the organized words:
a key under which the value is indexed;
a payload of posting lists, wherein each posting list is represented as a binary number; and
an indicator of size of the payload.

20. The non-transitory computer-readable medium of claim 14, wherein the method further comprises:
receiving a user request including a query word and a query column;
using the key to identify faceted rows that contain the query word in the query column; and
processing the identified faceted rows such that a response to the user request includes at least one of a summary distribution and an analysis computed using the identified facet rows.

21. The non-transitory computer-readable medium of claim 14, wherein the method further comprises caching every syntax of the query separately.

22. The non-transitory computer-readable medium of claim 14, wherein the method further comprises:
receiving a user request including a query word and a query column;
using the query word and query column to identify a posting list; and
using the posting list to identify source documents; and
processing rows from the source documents such that a response to the user request includes at least one of a summary distribution and an analysis computed over the rows from the source documents.

23. A computer-implemented method of processing data by creating an inverted column index, comprising:
categorizing words in a collection of source files according to data type;
generating a posting list for each of the words that are categorized;
encoding a key with a word of the categorized words, its data type, its column ordinal, an identifier for the source file from which the word came, the word's row position in the source file document, and a facet status to create the inverted column index;
encoding a value with the key by which the value is indexed and the posting list that is associated with the key;
selecting rows of the source files and faceting the selected rows by storing the selected rows in a facet list;
indicating, by using the facet status of a key, whether the row in the key is faceted;
in response to a query including a word and a column ordinal, using the keys in the inverted column index to identify source files that contain the word and the column of the query that are faceted; and
accessing the facet list to parse the faceted rows in an inverted column index format to allow preparation of a summary distribution or a summary analysis that shows most frequently appearing words in the source files that match the query.
